(19) United States
(12) Patent Application Publication
(10) Pub. No.: US 2010/0014880 A1
(43) Pub. Date: Jan. 21, 2010

(54) FIXING DEVICE, TEMPERATURE CONTROL METHOD OF FIXING DEVICE, AND IMAGE FORMING APPARATUS

(75) Inventors: Satoshi Kinouchi, Tokyo (JP); Yoshinori Tsueda, Shizuoka-ken (JP); Kazuhiko Kikuchi, Kanagawa-ken (JP); Osamu Takagi, Tokyo (JP); Toshihiro Sone, Kanagawa-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/478,709

(22) Filed: Jun. 4, 2009

Related U.S. Application Data
(60) Provisional application No. 61/081,689, filed on Jul. 17, 2008.

(30) Foreign Application Priority Data
Mar. 17, 2009 (JP) P2009-64939

(51) Int. Cl. G03G 15/20

(52) U.S. Cl. 399/67; 399/69

(57) ABSTRACT

A fixing device includes a heated body having a metal conductive layer, a pressing body to permit a sheet to pass through between the heated body and itself, a sheet detection portion to detect the sheet conveyed between the heated body and the pressing body, an induction heating coil to generate an induced current in the metal conductive layer, and a controller, on the basis of the detection results of the sheet detection portion, to detect a first boundary where a part of the sheet in contact with the heated body is switched to a part not in contact with the heated body and a second boundary where the part of the sheet not in contact with the heated body is switched to the part in contact with the heated body and when the first boundary and second boundary face the induction heating coil, changing the power value to be supplied to the induction heating coil.

### CROSS-REFERENCE TO RELATED APPLICATION

This application is based upon and claims the benefit of priority from the prior U.S. Patent Application No. 61/081,689, filed on. Jul. 17, 2008 and Japanese Patent Application No. 2009-64939, filed on Mar. 17, 2009; the entire contents of all of which are incorporated herein by reference.

### FIELD OF THE INVENTION

The present invention relates to a fixing device, a temperature control method of the same, and an image forming apparatus.

### DESCRIPTION OF THE BACKGROUND

As a fixing device used for an image forming apparatus such as a copying machine and a printer, there is a fixing device for inserting a sheet between a pair of rollers composed of a heating roller and a pressure roller or similarly into a nip formed between a heating belt and a pressure roller and heating, pressurizing, and fixing a toner image. As such a heating type fixing device, conventionally, there is a device for heating a metal conductive layer on the surface of the hearing roller or heating belt by the induction heating method. The induction heating method firstly supplies a predetermined high frequency current to an induction heating coil to generate a magnetic field, thus an eddy current is generated in the metal conductive layer by the magnetic field. If the current flows through the metal conductive layer like this, since the metal conductive layer has an electric resistance, Joule heat in correspondence to the power due to the current and resistance (the product of the square of the current and resistance) is produced. By the Joule heat produced in the metal conductive layer, the heating roller or heating belt is heated.

In such a fixing device, if the heat capacity of the heated body (the heating roller, heating belt) is small, when a sheet makes contact with the heated body, the heat is lost from the sheet and the surface temperature of the heated body is lowered. Therefore, a difference may appear between the surface temperature of the heated body before contact with the sheet and the surface temperature of the heated body after contact with the sheet. If the surface temperatures of the heated body are different from each other like this, a difference appears in the dissolving way of toner at the parts at different temperatures, thus there is a fear of an occurrence of fixing irregularities.

Further, the portion of the heated body free of contact with a sheet (between a sheet and a sheet, hereinafter referred to as inter-sheet), compared with the temperature of the heated body at the portion in contact with the sheet, since no heat is lost, rises in the surface temperature. Therefore, compared with the portion in contact with the sheet, the history of the portion of the heated body where the surface temperature raises remains in the heated body as a temperature difference and fixing irregularities may be caused to an image.

To solve the aforementioned problems, a fixing device for detecting sheets conveyed to the fixing device and so as to make the power supply pattern with the passage of time based on the sheet detection timing coincide with a predetermined pattern, controlling the power to be supplied to the induction heating coil is disclosed in Japanese Patent Application Publication No. 10-333489.

The fixing device disclosed in Japanese Patent Application Publication No. 10-333489, after detection of the sheets, on the basis of the preset power pattern, changes the power to be supplied to the induction heating coil with time without detecting the inter-sheet portion.

Further, the set value of the power pattern to be supplied to the induction heating coil by the fixing device described in Japanese Patent Application Publication No. 10-333489, when no sheets are fed to the heated body, is set on the basis of the temperature detected by the temperature detection means. Namely, during feeding of sheets, supply power is decided on the basis of the predicted value at the time of feeding no sheets.

However, when the heating capacity of the heated body is small or the image forming speed is high, during feeding of sheets, the surface temperature of the heated body may exceed the control temperature and it is difficult for the fixing device described in Japanese Patent Application Publication No. 10-333489 to cope with such a case, thus there is a room left for improvement.

### SUMMARY OF THE INVENTION

The present invention is intended to provide a fixing device capable of making the surface temperature of a heated body uniform, a temperature control method of the fixing device, and an image forming apparatus having the fixing device.

In an aspect of the present invention, there is provided a fixing device comprising: a heated body having a metal conductive layer; a pressing body to permit a sheet to pass through between the heated body and itself; a sheet detection portion to detect the sheet conveyed between the heated body and the pressing body; an induction heating coil to generate an induced current in the metal conductive layer; and a controller, on the basis of detection results of the sheet detection portion, to detect a first boundary where a part of the sheet in contact with the heated body is switched to the part not in contact with the heated body and a second boundary where the part of the sheet not in contact with the heated body is switched to the part in contact with the heated body and when the first boundary and the second boundary face the induction heating coil, changing a power value to be supplied to the induction heating coil.

Furthermore, in an aspect of the present invention, there is provided a temperature control method of a fixing device including a heated body having a metal conductive layer, a pressing body to permit a sheet to pass through between the heated body and itself, and an induction heating coil arranged in the neighborhood of the heated body having an induction heating coil to generate an induced current in the metal conductive layer, comprising: detecting the sheet conveyed between the heated body and the pressing body; detecting, on the basis of detection results of the sheet, a first boundary where an opposite part of the induction heating coil is switched from a part of the sheet in contact with the heated body to a part not in contact with the heated body and a second boundary where the opposite part of the induction heating coil is switched from the part of the sheet not in contact with the heated body to the part in contact with the heated body; and changing the power value to be supplied to the induction heating coil when the first boundary and the second boundary reach a part opposite to the induction heating coil.

In an aspect of the present invention, there is provided an image forming apparatus comprising: an image forming unit to form an image on a sheet; and a fixing device to fix the image on the sheet, wherein the fixing device includes: a heated body having a metal conductive layer; a pressing body to permit the sheet to pass through between the heated body and itself; a sheet detection portion to detect the sheet conveyed between the heated body and the pressing body; an induction heating coil to generate an induced current in the metal conductive layer; and a controller, on the basis of the detection results of the sheet detection portion, to detect a first boundary where a part of the sheet in contact with the heated body is switched to a part not in contact with the heated body and a second boundary where the part of the sheet not in contact with the heated body is switched to the part in contact with the heated body and when the first boundary and second boundary face the induction heating coil, changing the power value to be supplied to the induction heating coil.

### BRIEF DESCRIPTION OF THE DRAWINGS

FIG. 1 is a schematic cross sectional view showing the image forming apparatus of the first embodiment of the present invention;

FIG. 2 is a schematic cross sectional view showing the fixing device of the first embodiment of the present invention;

FIG. 3 is a block diagram showing the control system for heating of the heating roller of the first embodiment of the present invention;

FIG. 4 is a drawing showing the relationship between the temperature of the heating roller and the fixing property of the fixing device;

FIG. 5 is a flow chart for showing the temperature control of the fixing device of the first embodiment of the present invention;

FIG. 6 is a drawing showing the relationship between the boundary value for the part in contact with a sheet and the supplied power value;

FIG. 7 is a schematic cross sectional view showing the fixing device having the heating belt of the first embodiment of the present invention;

FIG. 8 is a flow chart for showing the temperature control of the fixing device of the second embodiment of the present invention; and

FIG. 9 is a drawing showing the relationship between the boundary value and the supplied power value for the part in contact with a sheet.

### DETAILED DESCRIPTION OF THE INVENTION

Hereinafter, the embodiments of the present invention will be explained with reference to the accompanying drawings.

### First Embodiment

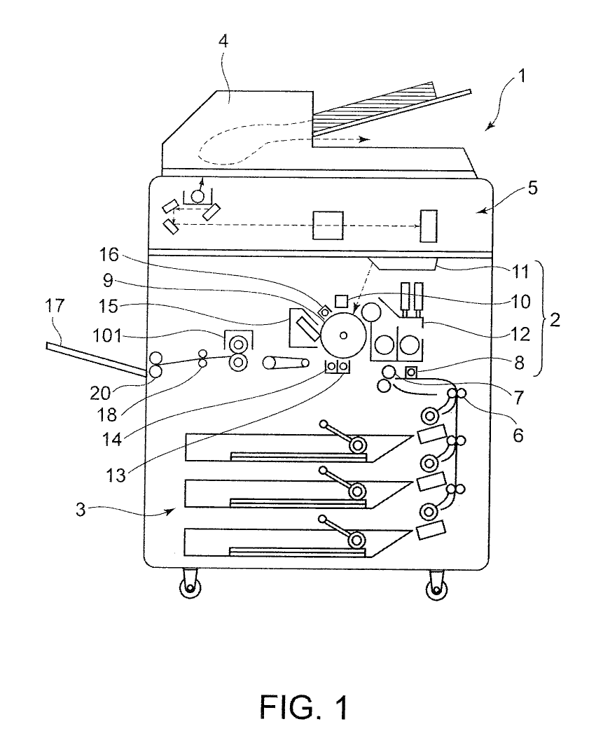

Hereinafter, the first embodiment will be explained by referring to FIGS. 1 to 7.

FIG. 1 is a schematic cross sectional view showing an image forming apparatus 1 for loading a fixing device 101 of this embodiment.

The image forming apparatus 1 has sheet cassette portions 3 for feeding sheets P which are fixed media to an image forming unit 2 on the lower part and a scanner unit 5 for reading a document supplied from an automatic document feeder 4 on the upper part. On a conveying path 6 from the sheet cassette portions 3 to the image forming unit 2, aligning rollers 7 are installed. This side of the aligning rollers 7, a position sensor 8 for detecting passing of the sheets P is installed.

The image forming unit 2 includes, sequentially around a photosensitive drum 9 in the rotational direction thereof (clockwise), a main charger 10 for uniformly charging the photosensitive drum 9, a laser exposing device 11, on the basis of image data from the scanner unit 5 and image data inputted externally, for forming a latent image on the charged photosensitive drum 9, a developing device, an image transferring charger 13, a sheet separation charger 14, a cleaner 15, and a neutralization LED 16. By use of such a constitution, the image forming unit 2 forms a toner image on the photosensitive drum 9 and transfers the toner image onto the sheets P.

In the downstream side of the image forming unit 2 in the conveying direction of the sheets P, an ejection sheet conveying path 18 for conveying the sheets P with the toner image transferred to toward a sheet receiving tray 17 is installed. On the ejection sheet conveying path 18, a fixing device 101 for fixing the toner of the sheets P separated from the photosensitive drum 9 and ejection rollers 20 for ejecting the sheets P passing through the fixing device 101 to the sheet receiving tray 17 are installed.

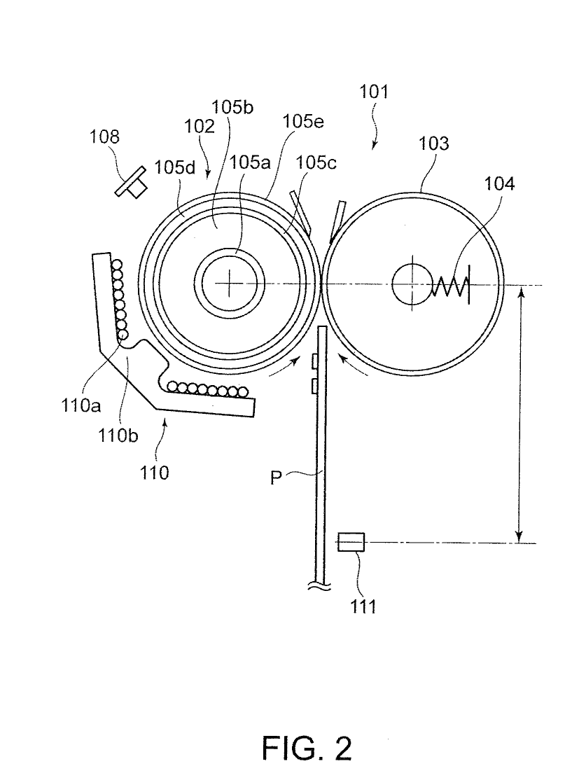

Next, the fixing device 101 will be described. FIG. 2 is a schematic cross sectional view showing the fixing device.

The fixing device 101 includes a heating roller 102 which is a heated body and a pressure roller 103 which is a pressing member for pressuring the heating roller 102 via each of the sheets P. The heating roller 102 is driven by a drive motor not drawn in the direction of the arrow shown in FIG. 2 and the pressure roller 103 is installed so as to make rolling contact with the heating roller 102 and be driven to rotate in the direction of the arrow shown in FIG. 2.

The heating roller 102 is composed of, sequentially from the inside, a cored bar 105a, foamed rubber (a sponge) 105b, a metal conductive layer 105c, a solid rubber layer 105d, and a release agent layer 105e. This embodiment is structured so that the foamed rubber 105b is 5 mm in thickness, and the metal conductive layer 105c is 40 μm in thickness, and the solid rubber layer 105d is 200 μm in thickness, and the release agent layer 105e is 30 μm in thickness. Further, as a material of the metal conductive layer 105c, nickel is used.

In this embodiment, as a material of the metal conductive layer 105c, nickel is used, though in addition to it, stainless steel, aluminum, or a composite material of stainless steel and aluminum may be used. The pressure roller 103 is structured so as to be coated with silicon rubber or fluorine rubber around the cored bar. The pressure roller 103 is pressurized to the heating roller 102 by a spring 104. The sheets P pass through the fixing point which is the pressurized portion (nip) between the heating roller 102 and the pressure roller 103, thus the toner image on each of the sheets P is melted, pressurized, and fixed.

Further, at the central part of the heating roller 102 in the longitudinal direction at the position separated from the heating roller 102, a temperature detecting sensor 108 is arranged. The temperature detecting sensor 108 detects the surface temperature of the heating roller 102.

Next, the heating device will be explained. The heating device has an induction heating coil 110 arranged on the outer periphery of the heating roller 102 and heats the heating roller 102 using an induction heating coil 110a of the induction heating unit 110.

The induction heating coil 110a is equipped with a magnetic core 110b at the center thereof, thereby can generate a large induction field independently of a small number of wire turns. Further, depending on the shape of the induction heating coil 110a, the magnetic flux can be focused on the metal conductive layer and the induction heating coil 110a is structured so as to heat the heating roller 102 locally intensively.

The induction heating coil 110a uses a copper wire with a wire diameter of 0.5 mm and is structured as a litz wire composed of several mutually insulated wires bundled. Due to formation of a litz wire, compared with one conductor with the same conductor area, the epidermal effect can be reduced and an AC current can be conducted effectively. In this embodiment, 19 copper wires with a diameter of 0.5 mm are bundled. Further, as a covering material of the coil, heat-resistant polyamide is used.

By a high frequency current impressed to the induction heating coil 110a from the inverter circuit which will be described later, a magnetic flux is produced. By the magnetic flux, so as to prevent the metal conductive layer 105c of the heating roller 102 from changing in the magnetic field, a magnetic flux and an eddy current are generated. Due to the eddy current and the resistance of the metal conductive layer 105c, Joule heat is produced and the heating roller 102 is heated.

Further, on the basis of the difference between the temperature detected by the temperature detecting sensor 108 and a set temperature of the heating roller 102, the power to be outputted to the induction heating coil 110a is changed and the fixing temperature of the heating roller 102 is maintained.

Further, on the upstream side of the entrance of the fixing device 101, a sheet detecting sensor 111 for detecting the sheets P conveyed is installed. If the leading edge or trailing edge of the sheets P passes through the sheet detecting sensor 111, a signal is sent from the sheet detecting sensor 111 to the controller (CPU 303) and the signal is used as a criterion for controlling the power of the induction heating coil 110a.

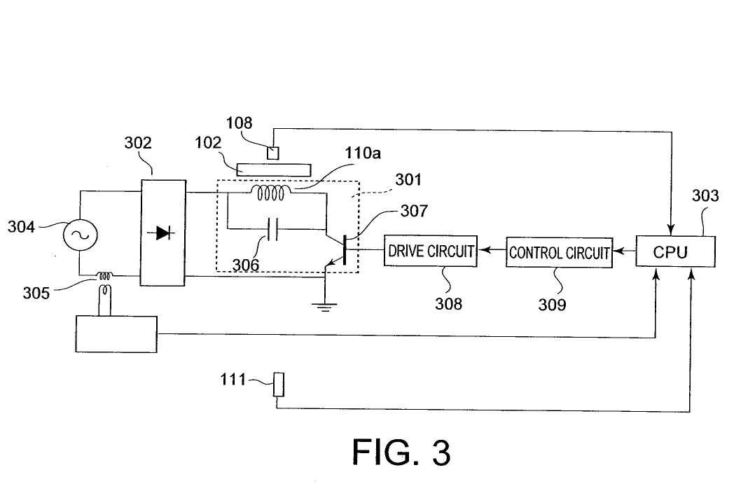

Next, the control system for heating the heating roller 102 will be explained by referring to FIG. 3.

FIG. 3 is a block diagram showing the control system relating to the heating of the heating roller 102. Namely, the control system is a portion for functioning as a high frequency current supply portion for supplying a high frequency current to the induction heating coil 110a. The control system includes an inverter circuit 301 for supplying a drive current to the induction heating coil 110a, a rectifier circuit 302 for supplying a DC current to the inverter circuit 301, and a CPU 303 for controlling the inverter circuit 301 according to the detection results of the sheets P by the sheet detecting sensor 111 and the detection results of the temperature detecting sensor 108.

The rectifier circuit 302 converts a current from a commercial AC source 304 to a DC current by rectifying and smoothing and supplies it to the inverter circuit 301. Between the rectifier circuit 302 and the commercial AC source 304, an electric power detection portion (transformer) 305 is arranged and the power value supplied to the induction heating coil 110a can be detected. The electric power detection portion 305 detects the supplied power value and feeds it back to the CPU 303.

The inverter circuit 301 is structured so that a resonance capacitor 306 is connected in parallel to the induction heating coil 110a and a switching element 307 is serially connected to the resonance circuit. For the switching element 307, an IGBT (insulating gate bipolar transistor) which is highly dielectric and is usable at a large current is used. The switching element 307 may be a MOS-FET.

To the control terminal of the switching element 307, a drive circuit 308 is connected. The drive circuit 308 impresses the drive voltage to the control terminal of the switching element 307 to turn on or off the switching element 307. A control circuit 309 connected to the drive circuit 308 outputs the timing for impressing the drive voltage to the switching element 307 from the drive circuit 308. Namely, the ON time of the switching element 307 depends on the control circuit 309 and the control circuit 309, by feeding back the supply power to the inverter circuit 301, changes the ON time and then changes the supply power.

If the ON time of the switching element 307 is increased, the supply power to the inverter circuit 301 is increased. Further, if the ON/OFF time of the switching element 307 is changed, the time of one cycle of the current flowing through the induction heating coil 110a is changed, so that the drive frequency is changed. In this embodiment, the frequency is changed within the range from 20 KHz to 100 KHz and the supply power is changed within the range from 200 W to 1000 W.

Next, the control method for changing the power value supplied to the induction heating coil 110a during image formation and keeping uniformly the temperature distribution of the heating roller 102 in the circumferential direction will be explained.

As described above, if the heat capacity of the heating roller 102 is small, between the time when the sheets P pass between the heating roller 102 and the pressure roller 103 (that is, when the sheets P are in contact with the heating roller) and the time when the sheets P do not pass (that is, when the sheets P are not in contact with the heating roller: between the sheets), the quantity of heat lost from the heating roller 102 is different. Namely, when the sheets P pass through, the heating roller 102 lowers in temperature because the heat is lost to the sheets P, while when the sheets P do not pass through, the heat is not lost so much, thus the temperature distribution differs during one cycle of the heating roller 102.

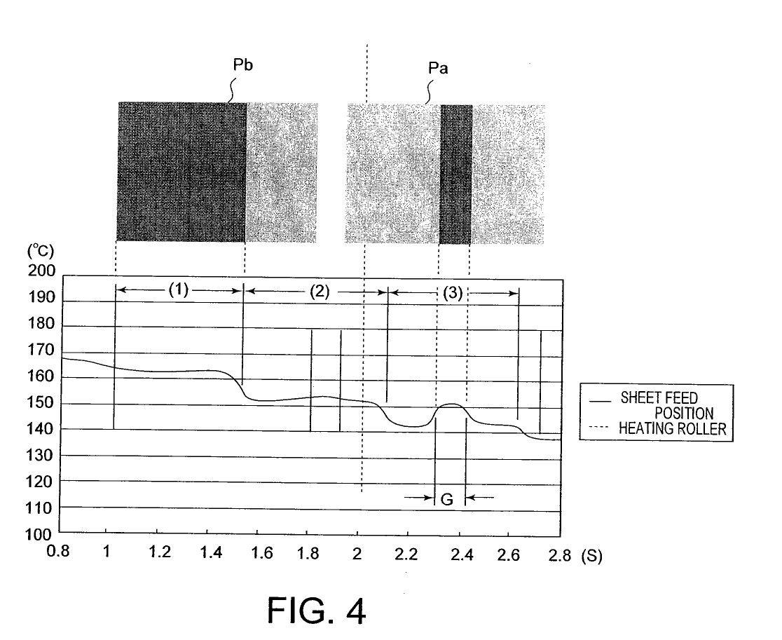

FIG. 4 is a drawing showing the relationship between the temperature of the heating roller 102 and the fixing property to the sheets P, in which uniform power is supplied to the induction heating coil 110a.

The drawings above the graph indicate the fixing property to the sheets P and the four-sided figures show one sheet and transfers and fixes black toner to overall the sheet P. The graph shown below indicates the time in the horizontal axis and the surface temperature of the heating roller 102 in the vertical axis to show the temperature change with time of the heating roller 102. Further, the four-sided figures in the graph indicate the passing time of the sheets P and the numerals in the parentheses indicate the rotational cycle of the heating roller 102.

In the graph on the lower part of FIG. 4, while the first sheet Pb passes through the heating roller 102, the heating roller makes a round and in the second round, the temperature of the heating roller 102 lowers suddenly. Due to the sudden temperature change of the heating roller, as shown above the graph, during passing of the sheet Pb, the black fixed to the sheet Pb is lightened. Further, in the sheet Pa, the temperature of the heating roller 102 rises before and after it (the portion of G), thus at the central part of the sheet A, the portion where the fixed black is deepened appears. Namely, it may be said that due to the sudden temperature change of the heating roller 102, the fixing property to the sheet P is lowered. Due to the sudden temperature change of the heating roller 102, the fixing property to the sheet P is changed like this, so that there is a fear that uneven fixing may be caused to an image formed on the sheet P.

The temperature control method for the heating roller 102 to reduce an occurrence of such a sudden temperature change in the heating roller 102 will be described below.

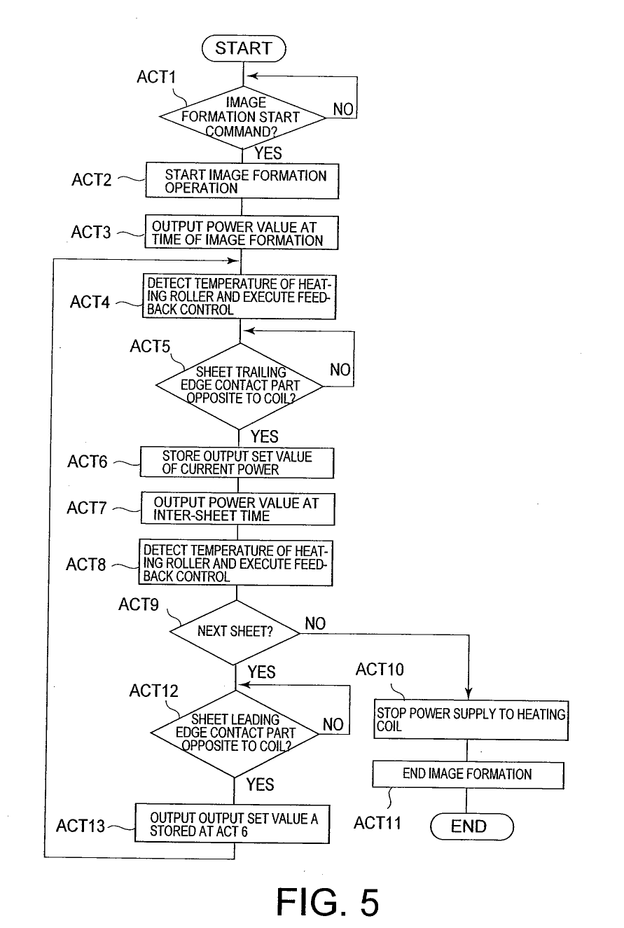

FIG. 5 is a flow chart of the temperature control of the heating roller 102 of this embodiment.

In FIG. 5, an example of keeping the temperature of the heating roller 102 constant at the inter-sheet portion explained in FIG. 4 and controlling so as to prevent an occurrence of a sudden temperature change in the portion of G shown in FIG. 4 will be explained.

Firstly, the temperature control method permits a user to designate copy or a print job and judges whether an image formation start command is issued or not (ACT 1). When the image formation start command is issued (Yes at ACT 1), the method permits the user to start the image forming operation (ACT 2). If the image forming operation is started, the CPU 303 sets power necessary at the time of image formation and sends a signal to the control circuit 309 (ACT 3). The power necessary at the time of image formation is added like this, thus the heating roller 102 is raised to a predetermined temperature (fixing control temperature). In this embodiment, at the time of image formation, 1000 W is designated and a command is sent to the control circuit 309 from the CPU 303 so as to output 1000 W.

The control circuit 309 at the start time of image formation, by slowly increasing the ON time of the switching element 307, controls the power to 1000 W. The control circuit 309 stores the standard set value of the ON time of the switching element 307 for controlling the power to 1000 W, though due to the temperature of the heating roller 102 and the temperature of the induction heating coil 110a, the magnetic coupling between the induction heating coil 110a and the heating roller 102 is changed, so that by comparing it with the power value detected by the electric power detection portion 305, slowly changes the ON time of the switching element 307 and controls so as to make the power constant.

Namely, if the standard set value for designating 1000 W which is stored in the CPU 303 is directly sent to the control circuit 309, there is a fear that owing to the influences of the temperatures of the heating roller 102 and induction heating coil 110a, the gap between the heating roller 102 and the induction heating coil 110a, and the power variation of the input voltage, power of larger than 1000 W may be output. Therefore, the control circuit 309, when changing the power, gives a standard set value of smaller power than the target power, then by detecting the power value by the electric power detection portion 305, executes feedback control, and controls so as to slowly bring the power close to 1000 W (soft start).

If the power approaches 1000 W, on the basis of the difference between the temperature detected by the temperature detecting sensor 108 and the set temperature of the heating roller 102, the control circuit 309 executes the feedback control for the power to be supplied to the induction heating coil 110a and maintains the heating controller 102 at the fixing temperature (ACT 4).

Next, on the basis of the sheet detection signal indicating detection of the trailing edge of the sheet P by the sheet detecting sensor 111, the control circuit 309 judges whether the part of the heating roller 102 in contact with the trailing edge of the sheet faces the position of the induction heating coil 110a or not (ACT 5). The judgment is a judgment, on the basis of the detection results of the trailing edge of the sheet P by the sheet detecting sensor 111, of whether the first boundary where the part when the sheet makes contact with the heating roller 102 is switched to the part when the sheet does not make contact with the heating roller 102 reaches the position of the induction heating coil 110a or not.

Concretely, assuming the time required between detection of the trailing edge of the sheet by the sheet detecting sensor 111 and arrival of the part of the heating roller 102 in contact with the trailing edge at the induction heating coil 110a as t1, it can be calculated from the relationship between the total of the distance from the sheet detecting sensor 111 to the nip between the heating roller 102 and the pressure roller 103 and the distance from the nip to the position of the induction heating coil 110a and the sheet conveying speed. Therefore, the control circuit 309 stores beforehand the time t1 and judges that after the time t1 after detection of the trailing edge of the sheet P by the sheet detecting sensor 111, the first boundary reaches the position opposite to the induction heating coil 110a.

If the control circuit 309 judges at ACT 5 that the first boundary reaches the position of the induction heating coil 110a (YES at ACT 5), it executes control of reducing heating of the induction heating means 110 in correspondence to the region of the heating roller 102 in the circumferential direction where the inter-sheet portion passes. Namely, the control circuit 309 controls so as to reduce the supply power to the region of the heating roller 102 corresponding to the inter-sheet portion.

Concretely, the CPU 303, before controlling so as to reduce the power, stores the power output set value (the ON time of the switching element 307) which is outputted immediately before it (ACT 6). The output set value is a value which is set when the feedback control of detecting the temperature of the heating roller 102 and from the power standard set value stored in the CPU 303, on the basis of the detected temperature, changing the power value is executed. At this time, the power value is a first power value.

The CPU 303 stores the output set value immediately before changing the power and then reduces the power (ACT 7). The power value is a second power value. In this embodiment, reduction of the power to 300 W is set.

When reducing the power between sheets, the output set value for reducing the power to 300 W is given directly to the drive circuit 308, thus the power is changed instantaneously. The reason is that the time between sheets is very short, so that the power must be changed suddenly and soft start is too late for it.

In this case, as mentioned above, due to the temperatures of the heating roller 102 and induction heating coil 110a and the power variation of the input voltage, 300 W cannot be outputted correctly and there are possibilities of an occurrence of an output error. However, sudden changing of the power is more effective in changing the surface temperature of the heating roller 102. Therefore, even if 300 W is not outputted strictly, it is not questionable so much.

For such a reason, the output set value is given directly to the drive circuit 308.

Further, the power transfer time to 300 W may be the half-wavelength time (10 ms at 50 Hz) of the commercial AC source 304. The reason is that the electric power detection portion 305 detects the power in ½ of the period of the commercial AC source 304 at its minimum, so that in order to change the power value by detecting the power, ½ of the period of the commercial AC source 304 is the minimum power transfer time.

Thereafter, when detecting the power by the electric power detection portion 305 and maintaining the power at 300 W, the CPU 303 adjusts the ON time of the switching element 307 and executes control of maintaining 300 W. Only when changing 1000 W to 300 W first, the CPU 303 gives the ON time based on the standard set value and then when the power approaches 300 W, on the basis of the difference between the temperature detected by the temperature detecting sensor 108 and the set temperature of the heating roller 102, executes feedback control for the power value supplied to the induction heating coil 110a and maintains the heating roller 102 at the fixing temperature (ACT 8).

As mentioned above, the region of the heating roller 102 where the inter-sheet portion passes is heated at 300 W. The power value supplied to the induction heating coil 110a is reduced like this, thus the inter-sheet portion of the heating roller 102 can prevent the surface temperature from rising higher than the portion in contact with the sheet P.

Next, on the basis of whether the sheet detecting sensor 111 detects the leading edge of the next sheet P or not, whether there is the next sheet P available or not is decided (ACT 9). If the leading edge of the sheet P is not detected (NO at ACT 9), the power supply to the induction heating coil 110a is stopped (ACT 10) and the image formation is finished (ACT 11).

On the other hand, if the sheet detecting sensor 111 detects the leading edge of the next sheet P (YES at ACT 9), the CPU 303, on the basis of the sheet detection signal from the sheet detecting sensor 111, judges, on the basis of the sheet detection signal from the sheet detecting sensor 111, whether the second boundary where the part that the sheet P does not make contact with the heating roller 102 is switched to the part that the sheet P makes contact with the heating roller 102 reaches the position of the induction heating coil 110a or not (ACT 12).

If the CPU 303 judges that the second boundary reaches the position of the induction heating coil 110a (YES at ACT 12), it instructs the control circuit 309 to change the power value to the one necessary at the time of image formation (the second power value). In this embodiment, the control of returning the power value to the one stored at ACT 6 is executed (ACT 13). Namely, the ON time of the switching element 307 of the inverter circuit 301 is given an output set value a (the ON time of the switching element 307) stored at ACT 6.

Under the ordinary power control, the soft start is executed, and the power is increased slowly, and on the basis of the detection results of the electric power detection portion 305, the feedback control is executed. However, if the soft start is executed, the power cannot be returned suddenly, so that to return the surface temperature of the heating roller 102 to its original condition, a little period of time is taken. Therefore, instead of the soft start, the output value is given directly. At this time, if the output value is assumed as a predetermined standard value, owing to the influences of the temperatures of the heating roller 102 and induction heating coil 110a and variations of the input voltage, there are possibilities that it may exceed the target power value and an eddy current may flow.

Therefore, in this embodiment, before the CPU 303 reduces the power, the output set value a stored at ACT 6 is given. The reason is that the time for keeping the power at 300 W is very short and the temperature conditions of the heating roller 102 and induction heating coil 110a and input voltage variations may be considered to be changed little.

After changing the power value to the second power value necessary at the time of image formation, the CPU 303 returns to ACT 4, on the basis of the difference between the temperature detected by the temperature detecting sensor 108 and the set temperature of the heating roller 102, executes the feedback control for the power to be outputted to the induction heating coil 110a, and maintains the heating roller 102 at the fixing temperature.

Thereafter, similarly to the aforementioned, the CPU 303 judges whether the first boundary corresponding to the trailing edge portion of the sheet faces the position of the induction heating coil 110a or not (ACT 5).

As mentioned above, regardless of whether it is the part where the heated body and the sheet make contact with each other or not, on the basis of the difference between the temperature detected by the temperature detecting sensor 108 and the set temperature of the heating roller 102, the CPU 303 executes the feedback control for the power supplied to the induction heating coil 110a. By repeating the aforementioned control, the temperature rise of the heating roller 102 among sheets can be prevented and the surface temperature of the heating roller 102 can be made uniform. Further, the CPU 303 always detects the surface temperature of the heating roller 102 and executes the feedback control, so that the surface temperature will not exceed the control temperature.

Further, the power is changed suddenly, thus the temperature distribution of the heating roller 102 can be changed instantaneously. Furthermore, the CPU 303 stores the power value (output set value) immediately before changing the power and returns the power value to the concerned power value, thereby when returning the power, can prevent a problem such that the power exceeds greatly the set value and an eddy current flows.

Further, when executing the aforementioned control repeatedly, as a power set value at the inter-sheet time, the value immediately before changing the power to 300 W is stored and it may be used as a power set value at the inter-sheet time in the next period.

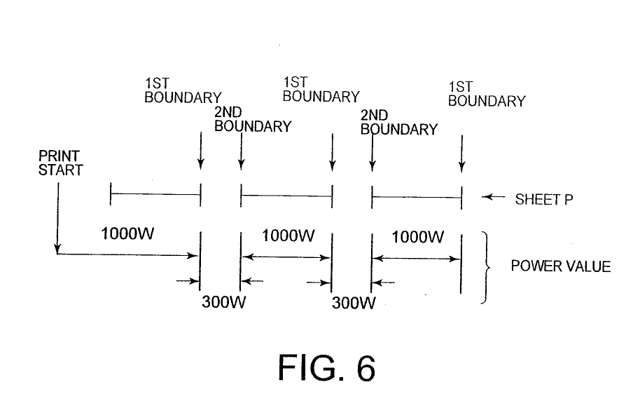

FIG. 6 shows the relationship between the boundary value for the part in contact with a sheet and the supplied power value.

Further, in this embodiment, the trailing edge of each of the sheets P conveyed to the fixing device 101 and the leading edge thereof are detected and the sheet intervals are confirmed. However, it is possible to detect first the size of the sheets P, and detect only the leading edge of each of the sheets P, and from the size of the sheets P, confirm the sheet intervals.

Further, lowering of the temperature of the heated body due to passing of the sheets P depends on the basis weight of the sheets P and the number of fed sheets. Therefore, in consideration of the basis weight of the sheets P and the number of fed sheets, control of changing the power value to be supplied at the inter-sheet time may be executed. Namely, as the basis weight of the sheets P is increased, the temperature of the heated body is lowered greatly, so that the basis weight is detected and due to the magnitude of the basis weight, the range of the power value to be changed between the sheets is changed. Further, as the number of fed sheets is increased, the temperature difference between the sheet feed portion and the inter-sheet portion is apt to decrease, so that it is effective, in correspondence to it, to change the power quantity to be changed in the sheet feed portion and inter-sheet portion.

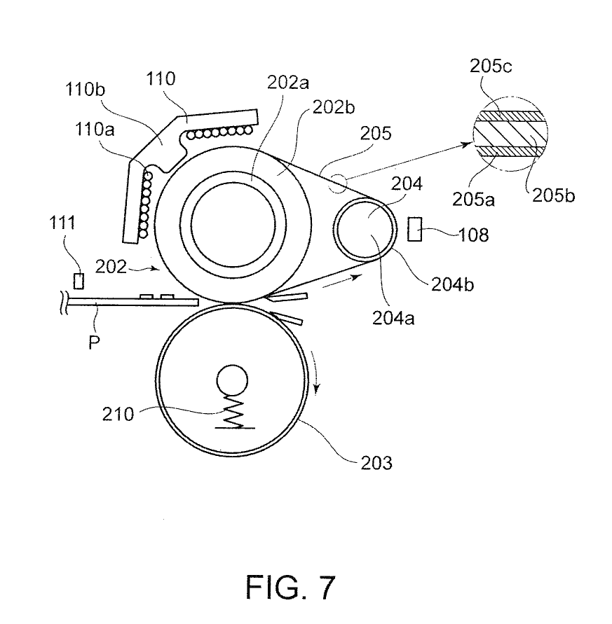

Further, in the embodiment aforementioned, the fixing device in a combination of the heating roller 102 and pressure roller 103 is explained, though a fixing unit having the constitution shown in FIG. 7 can produce the similar effect. The fixing device shown in FIG. 7 uses a constitution having a heat belt 205 suspended between a fixing roller 202 and a tension roller 204.

A pressure roller 203 is driven by a drive motor not drawn in the direction of the arrow shown in the drawing. The fixing roller 202, tension roller 204, and heat belt 205 are driven to rotate. Further, the pressure roller 203 is pressurized to the fixing roller 202 by a pressurization structure 210 and is kept so as to have a fixed nip width. Further, the heat belt 205 is stretched between the fixing roller 202 and the tension roller 204 at a fixed tension.

The fixing roller 202 is composed of, from the inside, a cored bar 202a and foamed rubber 202b. In this embodiment, the cored bar 202a is 2 mm in thickness and the foamed rubber 202b is 5 mm in thickness. The heat belt 205 is composed of, from the inside, sequentially a metal conductive layer 205a, a solid rubber layer 205b, and a release agent layer 205c. In this embodiment, as a material of the metal conductive layer, nickel is used. As a material of the metal conductive layer, in addition to it, stainless steel, aluminum, and a composite material of stainless steel and aluminum may be used.

The sheet P passes through the pressurized portion (nip) of the fixing roller 202, heat belt 205, and pressure roller 203, thus the toner image on the sheet is fused, pressurized, and fixed.

For the fixing device having such a constitution, the temperature control similar to that of the embodiment aforementioned is executed and the surface temperature of the heat belt can be made uniform.

According to the embodiment aforementioned, a difference appears in the surface temperature between the portion of the heated body (the heating roller 102 and heat belt 205) in contact with the sheet P and the portion not in contact with the sheet P and it can prevent formation of uneven gloss on an image. Further, the surface temperature of the heated body is always detected by the temperature detecting sensor 108, and the feedback control for the power value given to the induction heating coil 110a is executed, thus the temperature of the heated body can be kept at the fixing control temperature, and the heated body can be prevented from exceeding the control temperature and generating heat.

### Second Embodiment

The structures of the image forming apparatus 1 and fixing device 101 and the constitution of the inverter circuit 301 are the same as those of the first embodiment, so that the explanation thereof will be omitted.

According to this embodiment, the power control of changing the power value to be supplied in the first round of the heating roller 102 when feeding sheets P longer than the circumferential length of the heating roller 102, the power value to be supplied from the second round of the heating roller 102 up to the trailing edge of the sheets P, and the power value supplied between the sheets can be executed.

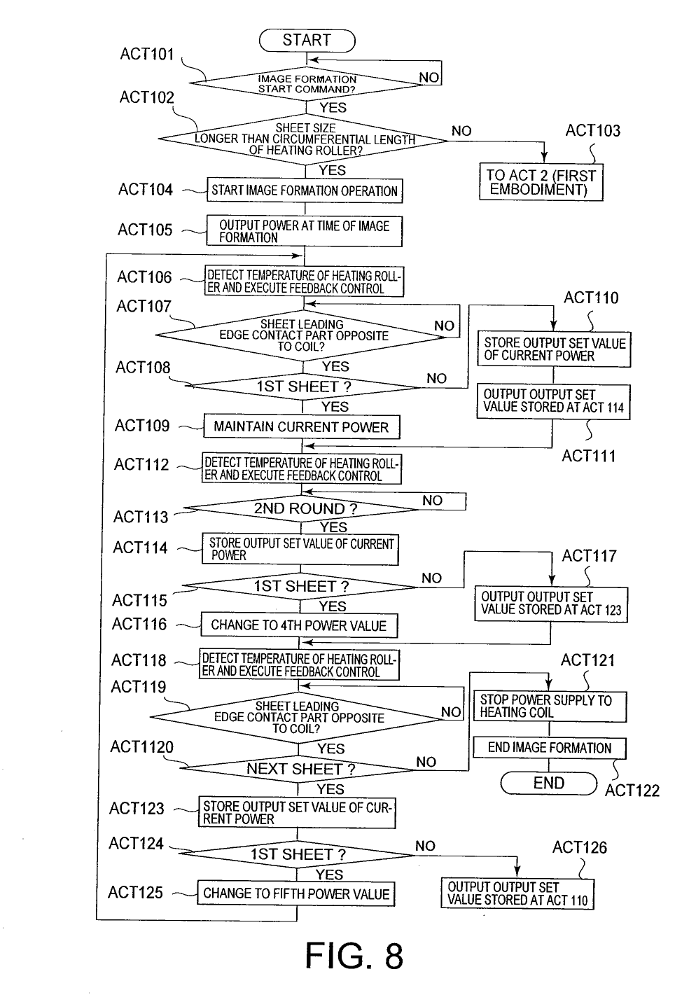

FIG. 8 is a flow chart of the power control of this embodiment. The flow chart will be explained.

Firstly, copy or a print job is designated by a user and whether an image formation start command is issued or not is judged (ACT 101). When the image formation start command is issued (Yes at ACT 101), whether the size of the sheets P is longer than the circumferential length of the heating roller 102 or not is decided (ACT 102). If the size of the sheets P is not longer than the circumferential length of the heating roller 102 (NO at ACT 102), the operations at ACT 2 and the succeeding ACTs of the flow chart shown in FIG. 5 in the first embodiment are performed (ACT 103).

If the size of the sheets P is longer than the circumferential length of the heating roller 102 (YES at ACT 102), the process goes to ACT 104 and the image forming operation is started (ACT 104).

If the image forming operation is started, the CPU 303 sets the power necessary for image formation and sends a signal to the control circuit 309 (ACT 105). In this embodiment, the power necessary at the time of image formation start is assumed as 800 W and a command is sent to the control circuit 309 from the CPU 303 so as to output 800 W. If the power of 800 W is outputted, the soft start is executed and then similarly to the first embodiment, so as to keep the temperature constant from the detection results of the temperature detecting sensor 108, the feedback control is executed (ACT 106).

The time t2 required between detection of the leading edge of the sheet P by the sheet detecting sensor 111 and arrival of the part of the heating roller 102 in contact with the leading edge of the sheet P at the induction heating coil 110a, the time t3 required for the contact portion with the sheet P to make a round of the heating roller 102, and the time t2 required between detection of the trailing edge of the sheet P and arrival of the part of the heating roller 102 in contact with the leading edge of the sheet P at the induction heating coil 110a, similarly to the first embodiment, can be obtained from the relationship between the total of the distance from the sheet detecting sensor 111 to the nip between the heating roller 102 and the pressure roller 103 and the distance from the nip to the position of the induction heating coil 110a and the sheet conveying speed. Therefore, the CPU 303 stores beforehand the time t2 and t3 and after the t2 and the t3 after detection of the leading edge of trailing edge of the sheet by the sheet detecting sensor 111, may control the power.

Namely, on the basis of the output of the sheet detecting sensor 111, the CPU 303 judges whether the part of the heating roller 102 in contact with the leading edge of the sheet P faces the position of the induction heating coil 110a or not (the fifth boundary) (ACT 107).

When it is judged that the contact part with the leading edge of the sheet P faces the induction heating coil 110a (YES at ACT 107), the CPU 303 judges whether the current sheet is a first sheet or not (ACT 108). When it is the first sheet (YES at ACT 108), the CPU 303 maintains 800 W which is a power value at the start time of the image formation operation (ACT 109).

At ACT 108, when it is judged that the current sheet is not the first sheet (NO at ACT 108), the CPU 303 stores the output set value of the power supplied at present (ACT 110). The output set value is a value which is set when the feedback control of detecting the temperature of the heating roller 102 at ACT 106 and from the power standard set value stored in the CPU 303, on the basis of the detected temperature, changing the power value is executed.

After storing the output set value of the current power at ACT 110, the CPU 303 changes it to the power value (the third power value stored at ACT 114) supplied at the end of the first round of the preceding sheet (ACT 111). After changing to the third power value, so as to keep the temperature constant from the detection results of the temperature detecting sensor 108, the feedback control is executed always (ACT 112).

Next, on the basis of the sheet detection signal, whether the time t4 required for the contact portion with the sheet P to make a round of the heating roller 102 elapses or not, that is, whether the second round (the third boundary) is started or not is judged (ACT 113). If the contact portion reaches the second round (YES at ACT 113), the CPU 303 firstly stores the output set value of the outputted power (the ON time of the switching element 307) (ACT 114). The power value at this time is the third power value.

And, the CPU 303 judges whether the sheet P is the first sheet or not (ACT 115) and if it is the first sheet, outputs the output set value of the power to be supplied to the induction heating coil 110a at the portion of the second round where the sheet P makes contact with the heating roller 102 by default (ACT 116). The power value at this time is the fourth power value.

In this embodiment, at the portion of the second round where the sheet P makes contact with the heating roller 102, a maximum output of 1000 W at the time of image formation is set. Further, in this embodiment, the power at the time of warming-up is assumed as 1000 W. The power set value of 1000 W after end of warming-up is stored, thus as an initial value of the fourth power, the concerned stored value is input. When the sheet P is not the first sheet at ACT 115 (NO at ACT 115), the CPU 303 changes it to the power value (the fourth power value stored at ACT 123) supplied at the end of the second round of the preceding sheet (ACT 117). After changing to the fourth power value, so as to keep the temperature constant from the detection results of the temperature detecting sensor 108, the feedback control is executed always (ACT 118).

Thereafter, on the basis of detection of the trailing edge of the sheet P by the sheet detecting sensor 111, the CPU 303 judges whether the part of the heating roller in contact with the trailing edge of the sheet faces the induction heating coil or not (the fourth boundary) (ACT 119). If the trailing edge of the sheet P faces it (YES at ACT 119), whether there is the next sheet available or not is judged (ACT 120). When there is no next sheet available, the power supply to the heating coil 110a is stopped (ACT 121) and the image formation is finished (ACT 122).

On the other hand, when there is the next sheet available at ACT 120 (YES at ACT 120), the CPU 303 firstly stores the output set value of the outputted power (the ON time of the switching element 307) (ACT 123). The power value at this time is the fourth power value. After storing the fourth power value, the CPU 303 judges whether the sheet P is the first sheet or not (ACT 124).

If the sheet P is the first sheet (YES at ACT 124), the CPU 303 changes it to the fifth power (300 W in this embodiment) which is the power value at the inter-sheet portion (ACT 125). When the sheet P is not the first sheet (NO at ACT 124), the CPU 303 changes it to the power value stored at the fifth boundary of the current sheet (the fifth power value stored at ACT 110) (ACT 126).

At ACT 124 or 126, after changing the power to be supplied to the induction heating coil 110a, the process returns to ACT 106 and so as to keep the temperature constant from the detection results of the temperature detecting sensor 108, the feedback control is executed always.

Thereafter, at ACT 107, whether the leading edge portion of the second sheet reaches the induction heating coil 110a or not is judged. Thereafter, the operation similar to the aforementioned is repeated, though at ACT 109, the second sheet is operated (NO at ACT 109), at ACT 111, the power value is changed to “the power value stored at ACT 114”. Further, also at ACT 115, the second sheet is operated (NO at ACT 115), so that at ACT 117, the power value is changed to “the power value stored at ACT 123”.

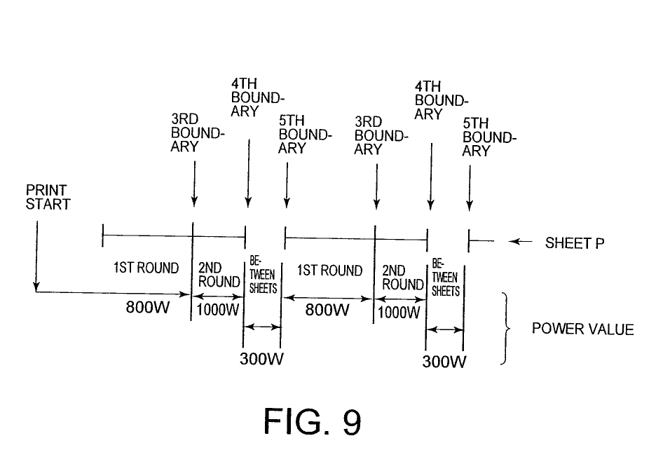

FIG. 9 shows the relationship between the boundary value and the supplied power value for the part in contact with a sheet.

In the flow chart aforementioned, the reason that the control of storing the output set value before hanging the power value and returning later to the concerned value is executed is to return to the stored power value similarly to the first embodiment, thereby, when returning the power, to prevent a problem that the power increases over greatly and an eddy current flows.

By repeating the aforementioned control, in addition to inter-sheet, at the portion of the first round where the sheet P makes contact with the heating roller and the portion of the second round, the power supplied to the induction heating coil 110a can be changed. This control is executed, thus even when the sheet P is longer than the circumferential length of the heating roller 102 and the power necessary at the time of image formation is the maximum output power, the temperature distribution of the heating roller 102 can be made uniform.

Further, similarly to the first embodiment, the temperature detecting sensor 108 detects always the surface temperature of the heating roller 102 and executes the feedback control for the power value to be given to the induction heating roller 110a, thereby can keep the temperature of the heating roller 102 at the fixing control temperature and prevent generation of heat due to excess of the control temperature.

Further, similarly to the first embodiment, in consideration of the basis weight of the sheets P and the number of fed sheets, the control of changing the power value to be supplied at the inter-sheet time may be executed. Further, the leading edge and trailing edge of each sheet are detected, and the parts where the respective edges make contact with the heating roller 102 are calculated, though it is possible to detect only the leading edge and calculate, from the size of the sheets, the part where the trailing edge makes contact with the heating roller 102.

Further, in the embodiment aforementioned, the fixing device 101 in a combination of the heating roller 102 and pressure roller 103 is explained, though similarly to the first embodiment, a fixing device having the heat belt 205 shown in FIG. 7 can produce the similar effect.

What is claimed is:

1. A fixing device comprising:
a heated body having a metal conductive layer;
a pressing body to permit a sheet to pass through between the heated body and itself;
a sheet detection portion to detect the sheet conveyed between the heated body and the pressing body;
an induction heating coil to generate an induced current in the metal conductive layer; and
a controller, on the basis of detection results of the sheet detection portion, to detect a first boundary where a part of the sheet in contact with the heated body is switched to the part not in contact with the heated body and a second boundary where the part of the sheet not in contact with the heated body is switched to the part in contact with the heated body and when the first boundary and the second boundary face the induction heating coil, changing a power value to be supplied to the induction heating coil.

2. The device according to claim 1, wherein the controller, when the first boundary faces the induction heating coil, stores a first power value supplied to the induction heating coil, then changes the first power value to a second power value, and when the second boundary faces the induction heating coil, changes the second power value to the stored first power value.

3. The device according to claim 1 further comprising:
a high frequency current supply unit to supply a high frequency current to the induction heating coil; and
an electric power detection portion to detect a supply power quantity from an AC source to supply power to the high frequency current supply unit,
wherein the controller executes feedback control for the power value supplied to the induction heating coil on the first boundary by comparing detection results of the electric power detection portion with set power and changes the power value for half-wavelength time of a frequency of the AC source.

4. The device according to claim 2 further comprising:
a temperature detection portion to detect a surface temperature of the heated body,
wherein the controller, regardless of whether it is the part where the heated body and the sheet make contact with each other or not, according to a difference between detection results of the temperature detection portion and a set temperature of the heated body, executes feedback control for the power value supplied to the induction heating coil.

5. The device according to claim 1, wherein the sheet detection portion detects a passing position of a leading edge of the sheet and a passing position of a trailing edge of the sheet.

6. The device according to claim 2, wherein the controller changes the second power value according to a basis weight of the sheet.

7. The device according to claim 2, wherein the controller changes the second power value according to the number of the sheets fed.

8. The device according to claim 1, wherein the controller, when a size of the sheet in a conveying direction is longer than a circumferential length of the heated body, on the basis of the detection results of the sheet detection portion, detects a third boundary between the part of the one sheet making contact firstly with the heated body and the part making contact secondarily, a fourth boundary where the part of the sheet in contact with the heated body is switched to the part not in contact with the heated body, and a fifth boundary where the part of the sheet not in contact with the heated body is switched to the part in contact with the heated body and when the third boundary, the fourth boundary, and the fifth boundary face the induction heating coil, changes the power value supplied to the induction heating coil.

9. The device according to claim 8, wherein the controller, when the third boundary faces the induction heating coil, stores a third power value supplied to the induction heating coil, then changes the third power value to a fourth power value, when the fourth boundary faces the induction heating coil, stores the fourth power value supplied to the induction heating coil, then changes the fourth power value to a fifth power value, furthermore when the fifth boundary faces the induction heating coil, changes the fifth power value to the third power value stored, and when the third boundary faces the induction heating coil, changes the third power value to the fourth power value stored.

10. The device according to claim 8 further comprising:
a high frequency current supply unit to supply a high frequency current to the induction heating coil; and
an electric power detection portion to detect a supply power quantity from an AC source to supply power to the high frequency current supply unit,
wherein the controller executes feedback control for the power value supplied to the induction heating coil on the fourth boundary by comparing detection results of the electric power detection portion with set power and changes the power value for half-wavelength time of a frequency of the AC source.

11. The device according to claim 9, wherein the controller changes the fourth power value according to a basis weight of the sheet.

12. The device according to claim 9, wherein the controller changes the fourth power value according to the number of the sheets fed.

13. A temperature control method of a fixing device including a heated body having a metal conductive layer, a pressing body to permit a sheet to pass through between the heated body and itself, and an induction heating coil arranged in the neighborhood of the heated body having an induction heating coil to generate an induced current in the metal conductive layer, comprising:
detecting the sheet conveyed between the heated body and the pressing body;
detecting, on the basis of detection results of the sheet, a first boundary where an opposite part of the induction heating coil is switched from a part of the sheet in contact with the heated body to a part not in contact with the heated body and a second boundary where the opposite part of the induction heating coil is switched from the part of the sheet not in contact with the heated body to the part in contact with the heated body; and
changing the power value to be supplied to the induction heating coil when the first boundary and the second boundary reach a part opposite to the induction heating coil.

14. The method according to claim 13, wherein the method, when the first boundary faces the induction heating coil, stores a first power value supplied to the induction heating coil, then changes the first power value to a second power value, and when the second boundary faces the induction heating coil, changes the second power value to the stored first power value.

15. The method according to claim 13 further comprising:
detecting, when a size of the sheet in a conveying direction is longer than a circumferential length of the heated body, on the basis of the detection results of the sheet detection portion, a third boundary between the part of the one sheet making contact firstly with the heated body and the part making contact secondarily, a fourth boundary where the part of the sheet in contact with the heated body is switched to the part not in contact with the heated body, and a fifth boundary where the part of the sheet not in contact with the heated body is switched to the part in contact with the heated body: and
changing the power value supplied to the induction heating coil on the third boundary, the fourth boundary, and the fifth boundary.

16. The method according to claim 15, wherein the method, when the third boundary faces the induction heating coil, stores a third power value supplied to the induction heating coil, then changes the third power value to a fourth power value, when the fourth boundary faces the induction heating coil, stores the fourth power value supplied to the induction heating coil, then changes the fourth power value to a fifth power value, furthermore when the fifth boundary faces the induction heating coil, changes the fifth power value to the third power value stored, and when the third boundary faces the induction heating coil, changes the third power value to the fourth power value stored.

17. The method according to claim 13 further comprising:
detecting a surface temperature of the heated body,
wherein the method executes feedback control for the power value according to a difference between the detection results of the surface temperature of the heated body and a set temperature of the heated body.

18. An image forming apparatus comprising:
an image forming unit to form an image on a sheet; and
a fixing device to fix the image on the sheet,
wherein the fixing device includes:
a heated body having a metal conductive layer;
a pressing body to permit the sheet to pass through between the heated body and itself;
a sheet detection portion to detect the sheet conveyed between the heated body and the pressing body;
an induction heating coil to generate an induced current in the metal conductive layer; and
a controller, on the basis of the detection results of the sheet detection portion, to detect a first boundary where a part of the sheet in contact with the heated body is switched to a part not in contact with the heated body and a second boundary where the part of the sheet not in contact with the heated body is switched to the part in contact with the heated body and when the first boundary and second boundary face the induction heating coil, changing the power value to be supplied to the induction heating coil.

19. The apparatus according to claim 18, wherein the controller, when a size of the sheet in a conveying direction is longer than a circumferential length of the heated body, on the basis of the detection results of the sheet detection portion, detects a third boundary between the part of the one sheet making contact firstly with the heated body and the part making contact secondarily, a fourth boundary where the part of the sheet in contact with the heated body is switched to the part not in contact with the heated body, and a fifth boundary where the part of the sheet not in contact with the heated body is switched to the part in contact with the heated body and when the third boundary, the fourth boundary, and the fifth boundary face the induction heating coil, changes the power value supplied to the induction heating coil.

20. The apparatus according to claim 18, wherein the controller, when the first boundary faces the induction heating coil, stores a first power value supplied to the induction heating coil, then changes the first power value to a second power value, and when the second boundary faces the induction heating coil, changes the second power value to the stored first power value.
